(19) United States
(12) Patent Application Publication
(10) Pub. No.: US 2023/0259389 A1
(43) Pub. Date: Aug. 17, 2023

(54) ELECTRONIC DEVICE AND ACTIVATION MANAGEMENT METHOD

(71) Applicant: HONDA MOTOR CO., LTD., Tokyo (JP)

(72) Inventor: Kengo Fukuta, Tokyo (JP)

(21) Appl. No.: 18/155,991

(22) Filed: Jan. 18, 2023

(30) Foreign Application Priority Data
Feb. 15, 2022 (JP) 2022-021276
Aug. 30, 2022 (JP) 2022-137215

(51) Int. Cl. G06F 9/48; B60R 25/24; B60R 16/023

(52) U.S. Cl. CPC G06F 9/4806; B60R 25/24; B60R 16/023

(57) ABSTRACT

An electronic device includes: a reception unit that receives an execution request to execute a function in which at least one of a plurality of processing devices is involved; and an activation unit that, when the reception unit receives the execution request, shifts all or some of the processing devices to activated states, and the activation unit, when the reception unit receives the execution request, executes a shifting process to shift the plurality of processing devices to the activated states according to activation ranks respectively assigned to the processing devices, in descending order of the activation ranks, but in the shifting process, does not shift, to the activated states, the processing devices having lower activation ranks than one of the processing devices determined according to the received execution request.

### INCORPORATION BY REFERENCE

The present application claims priority under 35 U.S.C. § 119 to Japanese Patent Application No. 2022-021276 filed on Feb. 15, 2022 and Japanese Patent Application No. 2022-137215 filed on Aug. 30, 2022. The content of applications is incorporated herein by reference in its entirety.

### BACKGROUND OF THE INVENTION

### Field of the Invention

The present invention relates to an electronic device that manages activation of a plurality of processing devices and an activation management method for processing devices.

### Description of the Related Art

Japanese Patent Laid-Open No. 2020-144565 discloses a technique for executing, in a multifunction peripheral (MFP) including a plurality of execution function units such as a print function unit, a copy function unit, and a FAX function unit, an individual initialization sequence for each of these execution function units in parallel processing.

### SUMMARY OF THE INVENTION

However, depending on the usage of MFPs at the users, for example, a situation in which the print function unit and the copy function unit are used very often, but the FAX function unit is rarely used can occur. Because in a conventional MFP as above, a plurality of execution function units are simultaneously initialized by processing an initialization sequence of each execution function unit in parallel, it is possible that, for example, the FAX function unit which is rarely used can keep waiting for an operation instruction for a long time in the initialized state.

Hence, if the above conventional technique is applied to an electronic device, for example, a control system in a vehicle, including a plurality of processing devices such as a processor, processing devices that will not be used in the immediate vehicle operations are unnecessarily activated and consume unnecessary electric power in a standby state (idle state), and this is not preferable from the viewpoint of energy efficiency.

An object of the present invention is to reduce electric power consumption in an electronic device that manages the operation of a plurality of processing devices by reducing the number of processing devices unnecessarily activated.

The above object contributes to, for example, reducing unnecessary electric power consumption in a vehicle and enables improvement in the energy efficiency in the automobile society, and thus, this can contribute to the realization of the Sustainable Development Goals (SDGs 7.3, 9.4, 12.2, and other targets).

An aspect of the present invention is an electronic device including: a reception unit that receives an execution request to execute a function in which at least one of a plurality of processing devices is involved; and an activation unit that, when the reception unit receives the execution request, shifts all or some of the processing devices to activated states, in which the activation unit, when the reception unit receives the execution request, executes a shifting process to shift the plurality of processing devices to the activated states according to activation ranks respectively assigned to the processing devices, in descending order of the activation ranks, but in the shifting process, does not shift, to the activated states, the processing devices having lower activation ranks than one of the processing devices determined according to the received execution request.

According to another aspect of the present invention, the plurality of processing devices include a physical machine and/or a virtual machine implemented in a processor.

According to another aspect of the present invention, the plurality of processing devices include a physical machine and/or a virtual machine implemented in a processor core included in a multicore processor.

According to another aspect of the present invention, the processing devices are devices mounted on a vehicle and involved in controlling the operation of the vehicle and include an entry processing device involved in a function for user entry to the vehicle, a travel-function processing device involved in a function for a traveling device of the vehicle, a monitoring processing device involved in a function of monitoring states of the vehicle and/or a driver, and an information-communication processing device involved in a function for an in-vehicle human-machine interface and/or a function for connection of communication between the vehicle and an external device.

According to another aspect of the present invention, the activation ranks are assigned in advance sequentially to the entry processing device, the travel-function processing device, the monitoring processing device, and the information-communication processing device from the highest rank.

According to another aspect of the present invention, the execution requests include a key unlocking request for unlocking a vehicle door with an electronic key, and in a case in which the execution request received by the reception unit is the key unlocking request, the one processing device determined according to the received execution request is the entry processing device, and the activation unit, in the shifting process, does not shift, to the activated states, the travel-function processing device, the monitoring processing device, and the information-communication processing device which have lower activation ranks than the entry processing device.

According to another aspect of the present invention, the execution requests include a door-handle unlocking request for unlocking a driver's seat door by a door-handle operation, and in a case in which the execution request received by the reception unit is the door-handle unlocking request, the one processing device determined according to the received execution request is the travel-function processing device, and the activation unit, in the shifting process, does not shift, to the activated states, the monitoring processing device and the information-communication processing device which have lower activation ranks than the travel-function processing device.

According to another aspect of the present invention, the execution requests include a driver's-seat-door related request for an opening operation of a driver's seat door, and in a case in which the execution request received by the reception unit is the driver's-seat-door related request, the one processing device determined according to the received execution request is the monitoring processing device, and the activation unit, in the shifting process, does not shift, to the activated state, the information-communication processing device which has a lower activation rank than the monitoring processing device.

According to another aspect of the present invention, the execution requests include a non-driver's-seat-door related request for an opening operation of doors other than a driver's seat door, and in a case in which the execution request received by the reception unit is the non-driver's-seat-door related request, the one processing device determined according to the received execution request is the travel-function processing device, and the activation unit, in the shifting process, does not shift, to the activated states, the monitoring processing device and the information-communication processing device which have lower activation ranks than the travel-function processing device.

According to another aspect of the present invention, the execution requests include a charge related request for charging the vehicle from an external charging device, and in a case in which the execution request received by the reception unit is the charge related request, the one processing device determined according to the received execution request is the travel-function processing device, and the activation unit, in the shifting process, does not shift, to the activated states, the monitoring processing device and the information-communication processing device which have lower activation ranks than the travel-function processing device.

Another aspect of the present invention is an activation management method executed by a computer of an electronic device that manages activation of a plurality of processing devices, the method including: receiving an execution request to execute a function in which at least one of a plurality of processing devices is involved; and shifting, when receiving the execution request, all or some of the processing devices to activated states, in which in the shifting, a shifting process is executed to shift the plurality of processing devices to the activated states according to activation ranks respectively assigned to the processing devices, in descending order of the activation ranks, but in the shifting process, the processing devices having lower activation ranks than one of the processing devices determined according to the received execution request are not shifted to the activated states.

With the aspects of the present invention, it is possible to reduce electric power consumption in an electronic device that manages the operation of a plurality of processing devices by reducing the number of processing devices unnecessarily activated.

### BRIEF DESCRIPTION OF THE DRAWINGS

FIG. 1 is a diagram illustrating the configuration of a vehicle control system including a central ECU which is an electronic device according to an embodiment of the present invention;

FIG. 2 is a diagram illustrating the configuration of the central ECU;

FIG. 3 is a diagram illustrating an example of an activation order of processing devices in a shifting process executed by an activation unit of the central ECU;

FIG. 4 is a diagram illustrating an example of a range of processing devices activated in the shifting process in the case in which a received execution request is a key unlocking request;

FIG. 5 is a diagram illustrating an example of a range of processing devices activated in the shifting process in the case in which a received execution request is a door-handle unlocking request, a non-driver's-seat-door related request, or a charge related request;

FIG. 6 is a diagram illustrating an example of a range of processing devices activated in the shifting process in the case in which a received execution request is a driver's-seat-door related request; and

FIG. 7 is a flowchart of a process to activate processing devices, executed by a reception unit and the activation unit of the central ECU.

### DETAILED DESCRIPTION OF THE PREFERRED EMBODIMENTS

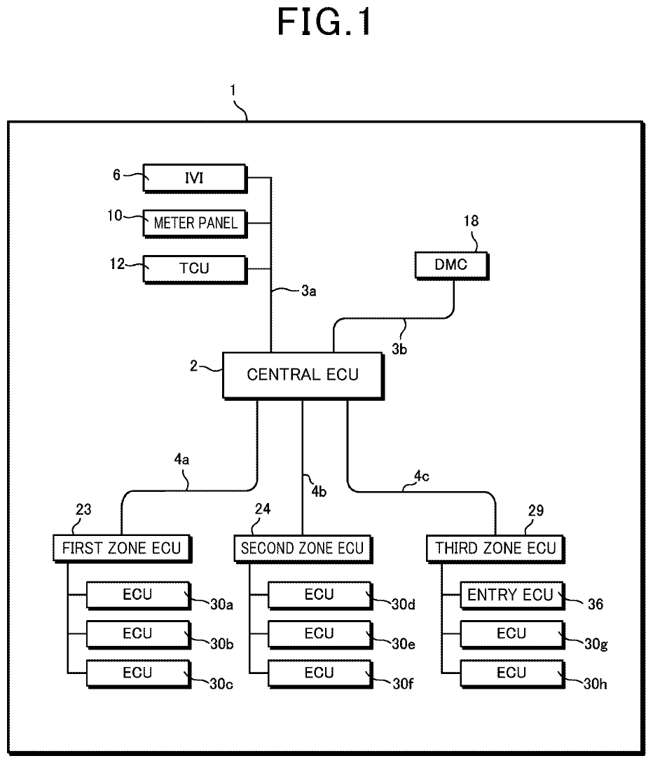

FIG. 1 is a diagram illustrating a vehicle control system 1.

The control system 1 includes a central ECU 2 that performs general control and information processing of a vehicle. The central ECU 2 is connected to communication lines including first communication lines 3a and 3b and second communication lines 4a, 4b, and 4c. The central ECU 2 implements a gateway function that manages transmission and reception of communication data between these communication lines. The central ECU 2 also executes over-the-air (OTA) management. The OTA management includes control for a process to download update programs for in-vehicle devices mounted on the vehicle from a server outside the vehicle and a process to apply the downloaded update programs to the in-vehicle devices.

The first communication lines 3a and 3b and the second communication lines 4a, 4b, and 4c are built based on buses to perform communication conforming to standards such as CAN and Ethernet (registered trademark) or communication lines for performing P2P (peer-to-peer) communication. Note that the first communication lines 3a and 3b may be a plurality of communication lines that perform communication conforming to the same standard or may be a plurality of communication lines that perform communication conforming to different standards. The same is true of the second communication lines 4a, 4b, and 4c.

The first communication line 3a is connected to an in-vehicle infotainment (IVI) 6, a meter panel 10, and a telematics control unit (TCU) 12. The IVI 6 uses a not-illustrated speaker, a microphone, a GNSS sensor, a touch panel, or the like to provide vehicle occupants with various kinds of information and entertainment. The meter panel 10 displays information on the operating state of the vehicle including the vehicle speed. The TCU 12 is a wireless communication device conforming to a communication standard of a mobile communication systems.

The first communication line 3b is connected to a driver monitoring camera (DMC) 18 for monitoring the driver.

The second communication lines 4a, 4b, and 4c are connected to a first zone ECU 23, a second zone ECU 24, and a third zone ECU 29, respectively. The first zone ECU 23 is connected to ECUs 30a, 30b, and 30c, and the second zone ECU 24 is connected to ECUs 30d, 30e, and 30f. The third zone ECU 29 is connected to an entry ECU 36, and ECUs 30g and 30h. The entry ECU 36 performs wireless communication with an electronic key of the host vehicle. The electronic key is an electronic device having a wireless communication function and is called a smart key or a fob key. The electronic key may be a mobile terminal such as a smartphone. The entry ECU 36 cooperates with other in-vehicle ECUs to process user access from the outside of the vehicle to the control system 1 and thus performs what is called the operation of smart entry.

Hereinafter, the ECUs 30a, 30b, 30c, 30d, 30e, 30f, 30g, and 30h are collectively called the ECUs 30.

The ECUs 30 may include, for example, a map positioning unit (MPU), an MVC-ECU (MVC: Multi View Camera), a PKS-ECU (PKS: Parking Support), and/or an ADAS-ECU (ADAS: Advanced Driver-Assistance System), and, in addition, other ECUs for controlling the operation of various devices and sensors included in the host vehicle. Such devices and sensors may include a drive motor that drives the host vehicle, driving operation devices such as the accelerator and the brake, a VSA device (VSA: Vehicle Stability Assist), a battery, lights such as head lamps, window motors that drive door windows, actuators that drive door lock mechanisms, door sensors, door open/close sensors, a temperature sensor, a vehicle-outside camera, and a vehicle-inside camera.

The first zone ECU 23, the second zone ECU 24, and the third zone ECU 29 are each connected to a plurality of ECUs 30 located in the same section in the vehicle body space of the host vehicle or a plurality of ECUs 30 that control the operation of devices and sensors located in the same section.

Note that the central ECU 2 may be connected not only to the first zone ECU 23, the second zone ECU 24, and the third zone ECU 29 but also to other control devices and equipment. Such control devices and equipment may include a camera, a speaker, a microphone, a steering switch, a GNSS sensor, and a touch panel.

### Embodiment

The central ECU 2 illustrated in FIG. 1 is an electronic device according to an embodiment of the present invention. The central ECU 2 in the present embodiment includes a plurality of processing devices that not only execute the foregoing gateway function and the OTA management function but also execute specified functions in conjunction with or in cooperation with other ECUs such as the third zone ECU 29. Then, the central ECU 2, in response to reception of an execution request from other ECUs or the like, shifts those processing devices to activated states.

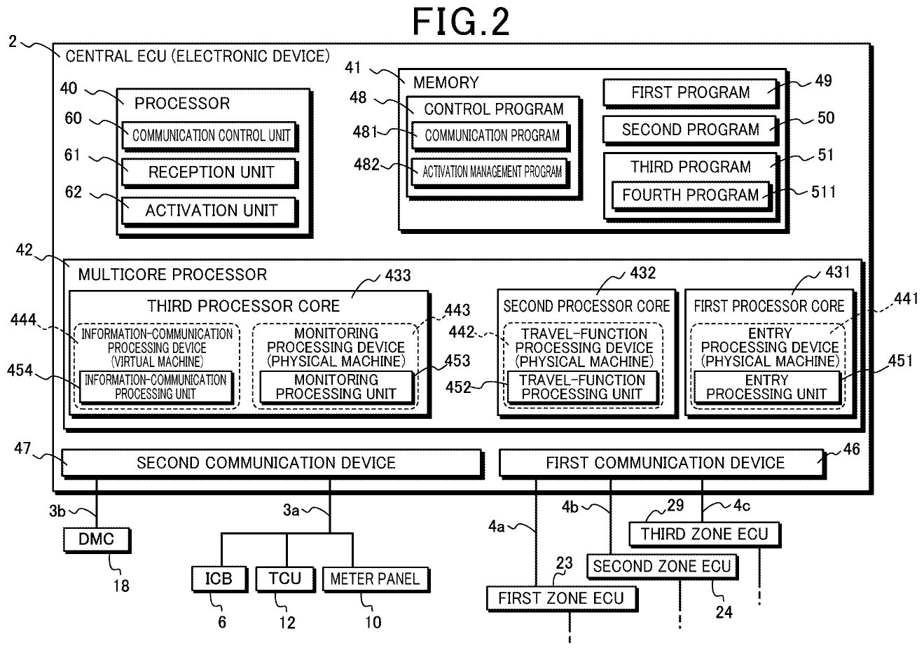

FIG. 2 is a diagram illustrating an example of the configuration of the central ECU 2.

The central ECU 2 includes a processor 40, a memory 41, a first communication device 46, and a second communication device 47, and also includes an entry processing device 441, a travel-function processing device 442, a monitoring processing device 443, and an information-communication processing device 444, which are computers implemented by a multicore processor 42. Here, the entry processing device 441, the travel-function processing device 442, the monitoring processing device 443, and the information-communication processing device 444 correspond to a plurality of processing devices in the present disclosure, which are mounted on a vehicle and involved in controlling the operation of the vehicle. The first communication device 46, and the second communication device 47 include a transceiver and a receiver,

The multicore processor 42 includes a plurality of processor cores capable of executing processing independently of one another. In the present embodiment, the multicore processor 42 includes three processor cores: a first processor core 431, a second processor core 432, and a third processor core 433. Hereinafter the first processor core 431, the second processor core 432, and the third processor core 433 are collectively called the processor cores 43.

The memory 41 includes, for example, volatile and/or nonvolatile semiconductor memory. The memory 41 has stored, in advance, a control program 48 that the processor 40 executes, a first program 49 that the first processor core 431 executes, a second program 50 that the second processor core 432 executes, and a third program 51 that the third processor core 433 executes. Note that these programs can be stored in any computer readable storage medium such as an optical disc, a magnetic disk, or flash memory. It can be assumed that the control program 48, the first program 49, the second program 50, and the third program 51, and update programs of these program can be downloaded according to conventional techniques from a server device (not illustrated) outside the host vehicle, communicably connected to the host vehicle. Here, in this specification, the host vehicle means a vehicle on which the control system 1 illustrated in FIG. 1 is mounted.

The first processor core 431 implements the entry processing device 441 including an entry processing unit 451 which is a function unit. This entry processing device 441 is activated in response to an activation instruction from an activation unit 62 of the processor 40, described later. Specifically, the entry processing device 441 is implemented in the first processor core 431 and starts its operation (in other words, is activated) by the first processor core 431 executing the first program 49 in response to the activation instruction from the activation unit 62.

The entry processing device 441 is involved in a function on the user entry to the host vehicle. The entry processing device 441 is activated, for example, based on an execution request from the third zone ECU 29 connected to the entry ECU 36 (see FIG. 1) that receives radio waves from the electronic key.

The second processor core 432 implements the travel-function processing device 442 including a travel-function processing unit 452 which is a function unit. This travel-function processing device 442 is activated in response to an activation instruction from the activation unit 62 of the processor 40. Specifically, the travel-function processing device 442 is implemented in the second processor core 432 and starts its operation by the second processor core 432 executing the second program 50 in response to the activation instruction from the activation unit 62.

The travel-function processing device 442 is involved in functions on traveling devices of the host vehicle. The travel-function processing device 442, by using the travel-function processing unit 452, manages the operation of the traveling devices, for example, in cooperation with the second zone ECU 24 connected to the traveling devices (not illustrated) such as a vehicle driving motor. The travel-function processing device 442 is activated, for example, when the user outside the host vehicle tried to unlock a door by an operation such as holding the door knob of the driver's seat door. Specifically, the travel-function processing device 442 is activated based on an execution request from the third zone ECU 29 connected to door sensors (not illustrated).

The third processor core 433 implements the monitoring processing device 443 including a monitoring processing unit 453 which is a function unit and the information-communication processing device 444 including an information-communication processing unit 454 which is a function unit. The monitoring processing device 443 and the information-communication processing device 444 are activated in response to activation instructions from the activation unit 62 of the processor 40. In the present embodiment, the monitoring processing device 443 is implemented as what is called a physical machine by the third processor core 433 executing the third program 51. The information-communication processing device 444 is implemented as what is called a virtual machine by the third processor core 433 executing a fourth program 511. The third program 51 and the fourth program each include an operating system (hereinafter called an OS).

Specifically, the monitoring processing device 443 is implemented on the hardware of the third processor core 433 in the third processor core 433 and starts its operation (in other words, is activated) by the third processor core 433 executing the third program 51 in response to an activation instruction from the activation unit 62. In this process, the third processor core 433 executes the OS included in the third program 51, so that a virtual machine platform provided by the OS is formed in the third processor core 433.

After that, in response to the activation instruction from the activation unit 62, the third processor core 433 executes the fourth program 511 on the above virtual machine platform to implement the information-communication processing device 444 which is a virtual machine.

Specifically, the OS provided by the third program 51 is what is called a host OS, and the OS provided by the fourth program 511 is what is called a guest OS executed on the virtual machine platform provided by the host OS. The monitoring processing unit 453 included in the monitoring processing device 443 can be implemented by an application program executed on the above host OS, and the information-communication processing unit 454 included in the information-communication processing device 444 can be implemented by an application program executed on the above guest OS.

The monitoring processing device 443 is involved in functions of monitoring the states of the host vehicle and/or the driver. The monitoring processing device 443, by using the monitoring processing unit 453, for example, obtains an image of the driver from the DMC 18 when the driver's seat door of the host vehicle is opened. Personal authentication of the driver is performed based on the image of the driver received from the monitoring processing device 443, so that it is possible to perform vehicle settings (seat position, music, display screen layout, and the like) for the driver recognized when the vehicle operation is started.

For example, the monitoring processing device 443 performs detection from information from the second zone ECU 24 that the battery (not illustrated) has got connected to a charging device outside the host vehicle and displays information on the state of charging on the meter panel 10 (FIG. 1).

The monitoring processing device 443 is activated, for example, based on an execution request from the third zone ECU 29 connected to the door sensors or an execution request from the second zone ECU 24 connected to the above battery.

The information-communication processing device 444 is involved in functions for human-machine interfaces such as the IVI 6 mounted on the host vehicle and/or a not-illustrated touch panel, the steering switch, and the like and a function for communication between the host vehicle and external devices via the TCU 12 and/or a not-illustrated V2X communication device, the GNSS sensor, and the like.

The information-communication processing device 444, by using the information-communication processing unit 454, for example, starts the operation of human-machine interfaces such as the IVI 6, the touch panel, and the steering switch when the ignition switch or the power switch (both not illustrated) which is one of the driving operation devices is turned on. The information-communication processing device 444, by using the information-communication processing unit 454, for example, when the above ignition switch or power switch is turned on, establishes a communication connection with an external device associated with the TCU 12, the V2X communication device, the GNSS sensor, or the like to enable execution of the navigation function and the phone function that the IVI 6 can provide. Alternatively, the configuration may be such that when the power switch is turned on, human-machine interfaces such as the IVI 6, the touch panel, and the steering switch activate themselves by detecting a voltage change. In this case, each unit determines by itself whether to activate itself.

The information-communication processing device 444 is activated, for example, based on a voltage change at the time when the power switch is turned on. The information-communication processing device 444 is activated, for example, based on an execution instruction from the second zone ECU 24 connected to not-illustrated driving operation devices.

The processor 40, which is a computer included in the central ECU 2, includes, for example, at least one central processing unit (CPU). The processor 40 may include read only memory (ROM) in which programs are stored, random access memory (RAM) to store data temporarily, and the like.

The processor 40 includes a communication control unit 60, a reception unit 61, and the activation unit 62 which are function elements or function units. These function elements included in the processor 40 are implemented, for example, by the processor 40, a computer, executing the control program 48 stored in the memory 41. Specifically, the control program 48 includes a communication program 481 and an activation management program 482. The communication control unit 60 is implemented by the processor 40 executing the communication program 481, and the reception unit 61 and the activation unit 62 are implemented by the processor 40 executing the activation management program 482.

The communication control unit 60 implements, according to conventional techniques, a gateway function of managing transmission and reception of communication data between communication lines including the first communication lines 3a and 3b and the second communication lines 4a, 4b, and 4c. The communication control unit 60 executes, according to conventional techniques, the OTA management including control for a process to download update programs for in-vehicle devices mounted on the host vehicle from a server outside the vehicle and a process to apply the downloaded update programs to the in-vehicle devices.

The central ECU 2 manages activation of the entry processing device 441, the travel-function processing device 442, the monitoring processing device 443, and the information-communication processing device 444 by using the reception unit 61 and the activation unit 62.

The reception unit 61 receives an execution request to execute a function in which at least one of the entry processing device 441, the travel-function processing device 442, the monitoring processing device 443, and the information-communication processing device 444 is involved via the first communication device 46 or the second communication device 47. In the present embodiment, the reception unit 61, for example, receives the above execution request from the second zone ECU 24 and/or the third zone ECU 29 via the first communication device 46.

The execution requests that the reception unit 61 receives may include, for example, a key unlocking request for unlocking a vehicle door by using the electronic key, a door-handle unlocking request for unlocking the driver's seat door by a door-handle operation, and/or a driver's-seat-door related request for opening the driver's seat door. In addition, the execution requests that the reception unit 61 receives may include a non-driver's-seat-door related request for opening the doors other than the driver's seat door, an operation start request for starting the operation of the driving device by using the ignition switch or the power switch which is one of the driving operation devices, and/or a charge related request for charging the host vehicle from an external charging device.

The key unlocking request is received from, for example, the third zone ECU 29 connected to the entry ECU 36 that receives radio waves from the electronic key. The door-handle unlocking request, the driver's-seat-door related request, and the non-driver's-seat-door related request are received, for example, from the third zone ECU 29 connected to door sensors. The operation start request and the charge related request are received, for example, from the second zone ECU 24 connected to the driving operation devices and the battery. The operation start request may be outputted based on a voltage change (that the voltage is changed to a voltage larger than or equal to a specified voltage) at the time when the power switch is turned on. The operation start request may be outputted by the first processor core 431 based on the electronic key authentication result received from the third zone ECU 29.

When the reception unit 61 receives an execution request, the activation unit 62 shifts some or all of the entry processing device 441, the travel-function processing device 442, the monitoring processing device 443, and the information-communication processing device 444 to activated states. Hereinafter, the entry processing device 441, the travel-function processing device 442, the monitoring processing device 443, and the information-communication processing device 444 are collectively called the processing devices 44.

In the present embodiment, in particular, when the reception unit 61 receives an execution request, the activation unit 62 executes a shifting process to shift these processing devices 44 to the activated states in descending order of the activation ranks, according to the activation ranks respectively assigned to the processing devices 44. In the above shifting process, the processing devices 44 having lower activation ranks than one processing device 44 determined according to the above received execution request are not shifted to the activated states.

The activation ranks respectively assigned to the processing devices 44 can be determined in consideration of the use scene of the processing target of each processing device 44 (in the present embodiment, a door lock mechanism of the host vehicle, the battery, the DMC 18, and the like). As an example, in the present embodiment, the activation ranks respectively assigned to the processing devices 44 are determined according to the order of a series of user operations until the user of the vehicle gets in the vehicle and starts traveling of the vehicle.

Specifically, in the present embodiment, the activation ranks are assigned in advance, sequentially in order from the highest rank, to the entry processing device 441, the travel-function processing device 442, the monitoring processing device 443, and the information-communication processing device 444. More specifically, as to the above activation ranks, the entry processing device 441 is assigned to the highest level, level 1; the travel-function processing device 442 to the next highest level, level 2; the monitoring processing device 443 to the following lower level, level 3; and the information-communication processing device 444 to the lowest level, level 4. It can be assumed that this activation rank assignment is determined in advance and stored in the memory 41.

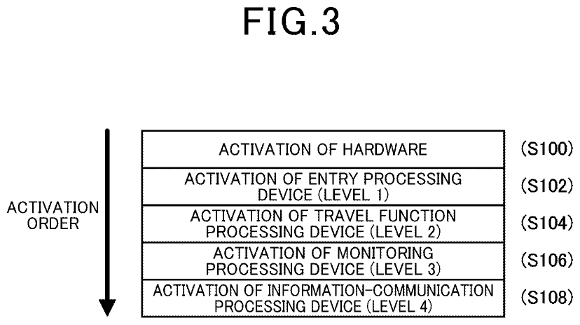

FIG. 3 is a diagram illustrating an example of the activation order of the shifting process executed by that the activation unit 62. In the example illustrated in FIG. 3, when the reception unit 61 receives an execution request, the activation unit 62 first activates the hardware included in the central ECU 2 (S100). Activation of the hardware may include, for example, a peripheral activation process in the multicore processor 42 which is activation preparation of the processor core (a return process to a normal operation mode when a peripheral has been shifted to a sleep mode).

After the activation of the hardware, the activation unit 62 activates, according to the foregoing activation ranks, the entry processing device 441 (S102) having the highest activation rank, and then, the activation unit 62 sequentially activates the travel-function processing device 442 (S104), the monitoring processing device 443 (S106), and the information-communication processing device 444 (S108).

However, as described above, in the present embodiment, the activation unit 62 in the shifting process, does not shift, to the activated states, the processing devices 44 having lower activation ranks than the one processing device 44 determined according to the above received execution request. The configuration may be such that the one processing device 44 determined according to the above execution request is, for example, determined in advance and stored in the memory 41.

Specifically, in the present embodiment, if the execution request received by the reception unit 61 is the key unlocking request received from the third zone ECU 29, the one processing device 44 determined according to the above received execution request is the entry processing device 441. If the execution request received by the reception unit 61 is the door-handle unlocking request received from the third zone ECU 29, the one processing device 44 determined according to the above received execution request is the travel-function processing device 442. If the execution request received by the reception unit 61 is the driver's-seat-door related request received from the third zone ECU 29, the one processing device 44 determined according to the above received execution request is the monitoring processing device 443.

If the execution request received by the reception unit 61 is the non-driver's-seat-door related request from the third zone ECU 29 or the charge related request received from the second zone ECU 24, the one processing device 44 determined according to the above received execution request is the travel-function processing device 442. If the execution request received by the reception unit 61 is the operation start request received from the second zone ECU 24, the one processing device 44 determined according to the above received execution request is the information-communication processing device 444.

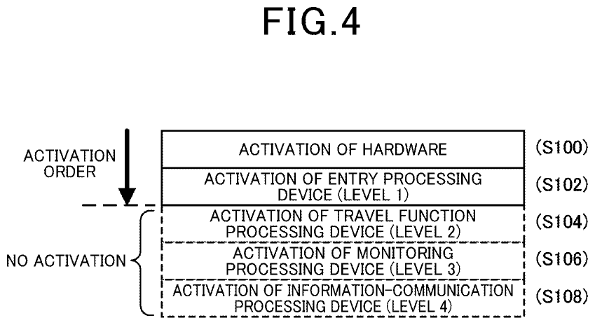

Then, if the execution request received by the reception unit 61 is the key unlocking request, the activation unit 62, in the shifting process, as illustrated in FIG. 4, does not shift, to the activated states, the travel-function processing device 442, the monitoring processing device 443, and the information-communication processing device 444 which have lower activation ranks than the entry processing device 441 which is the one processing device 44 determined according to the above execution request.

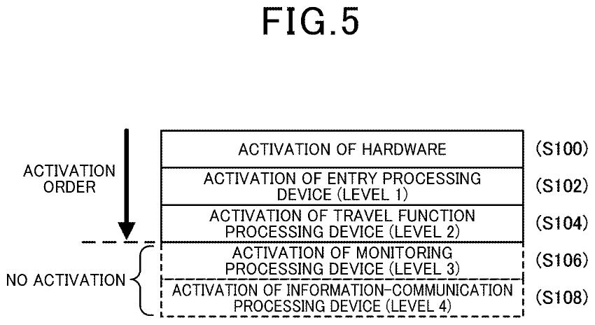

If the execution request received by the reception unit 61 is the door-handle unlocking request, the non-driver's-seat-door related request, or the charge related request, the activation unit 62, in the shifting process, as illustrated in FIG. 5, does not shift, to the activated states, the monitoring processing device 443 and the information-communication processing device 444 which have lower activation ranks than the travel-function processing device 442 which is the one processing device 44 determined according to the above execution request.

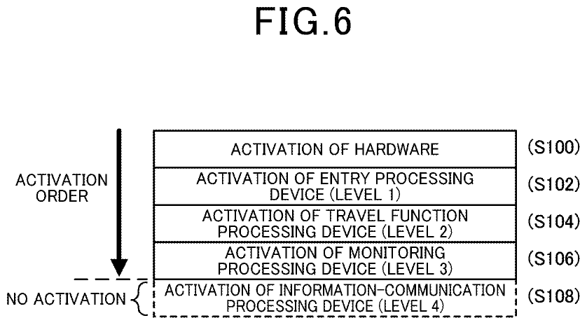

If the execution request received by the reception unit 61 is the driver's-seat-door related request, the activation unit 62, in the shifting process, as illustrated in FIG. 6, does not shift, to the activated state, the information-communication processing device 444 which has a lower activation rank than the monitoring processing device 443 which is the one processing device 44 determined according to the above execution request.

Note that when the reception unit 61 receives an execution request, if there are processing devices 44 that have already been activated, the activation unit 62 does not activate again those already-activated processing devices 44 and leaves them in their operational states.

The above configuration enables the central ECU 2 to prevent unnecessary activation of the processing devices 44 based on the use scenes of the host vehicle. Hereinafter, the operation of the central ECU 2 will be described based on examples of several use scenes.

A first example of a use scene is an example in which the user of the vehicle, the driver, gets in the vehicle and starts traveling of the vehicle. In this example, the user of the vehicle first performs a door unlock operation with an electronic key at a position away from the host vehicle. This door unlock operation is received by the entry ECU 36. The entry ECU 36 notifies the third zone ECU 29 of the reception of the door unlock operation, and the third zone ECU 29 transmits the key unlocking request, which is an execution request, to the central ECU 2. The central ECU 2, by using the reception unit 61, receives the above key unlocking request which is an execution request.

The activation unit 62 of the central ECU 2, as illustrated in FIG. 4, activates the processing devices 44 according to the activation ranks, up to the entry processing device 441 which is the one processing device 44 determined according to the above received execution request being the key unlocking request. The activated entry processing device 441, for example, by using the entry processing unit 451, performs an authentication process on the key code received from the electronic key and unlocks the door lock.

Next, when the user of the vehicle, the above driver, opens the driver's seat door and gets in the vehicle, the third zone ECU 29 detects the opening operation on the driver's seat door with a door sensor and transmits the driver's-seat-door related request, which is an execution request, to the central ECU 2. The activation unit 62 of the central ECU 2, from the state shown in FIG. 4, further activates the processing devices 44 according to the activation ranks as illustrated in FIG. 6, up to the monitoring processing device 443 which is the one processing device 44 determined according to the above received execution request being the driver's-seat-door related request. The activated monitoring processing device 443 performs a personal authentication of the driver by using an image of the driver obtained from the DMC 18, and thus it is possible to perform vehicle settings for the driver recognized when the vehicle operation is started.

After that, when the user of the vehicle, the above driver, turns on the ignition switch or the power switch which is one of the driving operation devices, the second zone ECU 24 detects the on-operation and transmits the operation start request, which is an execution request, to the central ECU 2. With this operation, the activation unit 62 of the central ECU 2 has activated all the processing devices 44 including the information-communication processing device 444, and thus, all the functions of the host vehicle have got ready to be executed.

A second example of a use scene is, as in the first example, an example in which the user of the vehicle, the driver, gets in the vehicle and starts traveling of the vehicle. In the second example, unlike the first example, the user of the vehicle without performing a door unlock operation with the electronic key, approaches the host vehicle and holds the door handle of the driver's seat door to unlock the driver's seat door. The third zone ECU 29 detects the unlock operation with the door sensor and transmits the door-handle unlocking request, which is an execution request, to the central ECU 2, and the central ECU 2 receives this execution request.

The activation unit 62 of the central ECU 2 activates the processing devices 44 according to the activation ranks as illustrated in FIG. 5, up to the travel-function processing device 442 which is the one processing device 44 determined according to the above received execution request being the door-handle unlocking request. The reason why activation is performed up to the travel-function processing device 442 when the door-handle unlocking request is received as an execution request is that, when the user of the vehicle unlocks the driver's seat door, it is probable that the user of the vehicle will get in the vehicle and start traveling of the vehicle. The activated entry processing device 441, for example, by using the entry processing unit 451, performs an authentication process on the key code received from the electronic key and unlocks the door lock. The travel-function processing device 442 activated next, for example, instructs the second zone ECU 24 to diagnose whether there is no abnormality in the driving device, the battery, and the driving operation devices and thus starts preparing for traveling operation of the host vehicle.

Activation of the processing devices 44 after that is performed as in the foregoing first example of the use scene. Specifically, when the user of the vehicle, the above driver, opens the driver's seat door after that and gets in the vehicle, the third zone ECU 29 detects the unlocking operation with the door sensor and transmits the driver's-seat-door related request, which is an execution request, to the central ECU 2. The activation unit 62 of the central ECU 2 further activates the processing devices 44 according to the activation ranks as illustrated in FIG. 6, up to the monitoring processing device 443 which is the one processing device 44 determined according to the above received execution request being the driver's-seat-door related request. The activated monitoring processing device 443 performs a personal authentication of the driver by using an image of the driver obtained from the DMC 18, and thus it is possible to perform vehicle settings for the driver recognized when the vehicle operation is started.

Then, when the user of the vehicle, the above driver, turns on the ignition switch or the power switch which is one of the driving operation devices, the second zone ECU 24 detects the on-operation and transmits the operation start request, which is an execution request, to the central ECU 2. With this operation, the activation unit 62 of the central ECU 2 has activated all the processing devices 44 including the information-communication processing device 444, and thus, all the functions of the host vehicle have got ready to be executed.

A third example of a use scene is an example of a scene until a user of the vehicle who is a non-driver (for example, a passenger to be sit in the front passenger seat) gets in the vehicle. In this example, the user of the vehicle first performs a door unlock operation with an electronic key at a position away from the host vehicle. This door unlock operation is received by the entry ECU 36. The entry ECU 36 notifies the third zone ECU 29 of the reception of the door unlock operation, and the third zone ECU 29 transmits the key unlocking request, which is an execution request, to the central ECU 2. The central ECU 2, by using the reception unit 61, receives the above key unlocking request which is an execution request.

The activation unit 62 of the central ECU 2, as illustrated in FIG. 4, activates the processing devices 44 according to the activation ranks, up to the entry processing device 441 which is the one processing device 44 determined according to the above received execution request being the key unlocking request. The activated entry processing device 441, for example, by using the entry processing unit 451, performs an authentication process on the key code received from the electronic key and unlocks the door lock.

Next, when the user of the vehicle opens a door other than the driver's seat door, for example, the door of the front passenger seat and gets in the vehicle, the third zone ECU 29 detects the unlocking operation of the front passenger seat door with a door sensor and transmits a non-driver's-seat-door related request, which is an execution request, to the central ECU 2. The activation unit 62 of the central ECU 2 activates the processing devices 44 according to the activation ranks as illustrated in FIG. 5, up to the travel-function processing device 442 which is the one processing device 44 determined according to the above received execution request being the non-driver's-seat-door related request.

The reason why activation is not performed up to the monitoring processing device 443 when a non-driver's-seat-door related request is received as an execution request, unlike the case in which the driver's-seat-door related request is received is that since the user of the vehicle who gets in the vehicle to sit in a non-driver's seat is not a driver, there is no need to obtain an image of the driver from the DMC 18 for personal authentication, and thus, there is no need to activate the monitoring processing device 443.

A fourth example of a use scene is an example in which when all the processing devices 44 are off in the case in which a user of the vehicle who is the driver or a non-driver is using the host vehicle (for example, the state in which after the user gets in the vehicle, the power supply of the vehicle has been turned off, or the state in which the vehicle is parked in an area having charging equipment), a charging operation is performed from a charging device outside the vehicle to the battery. This charging operation may be, for example, an operation to connect the charging cable of the above charging device to the charging connector (not illustrated) of the battery, or an operation to open a charging lid (not illustrated) that is a lid member provided on the vehicle body of the host vehicle to access the above charging connector.

When the charging operation of connecting the above charging cable or opening the charging lid is performed, the second zone ECU 24 connected to the battery detects this charging operation and transmits the charge related request, which is an execution request, to the central ECU 2. The activation unit 62 of the central ECU 2 activates the processing devices 44 according to the activation ranks as illustrated in FIG. 5, up to the travel-function processing device 442 which is the one processing device 44 determined according to the above received execution request being the charge related request.

The above operation enables the central ECU 2 to prevent unnecessary activation of the processing devices 44 according to the use scene of the host vehicle and in turn to reduce the electric power consumed in these processing devices 44.

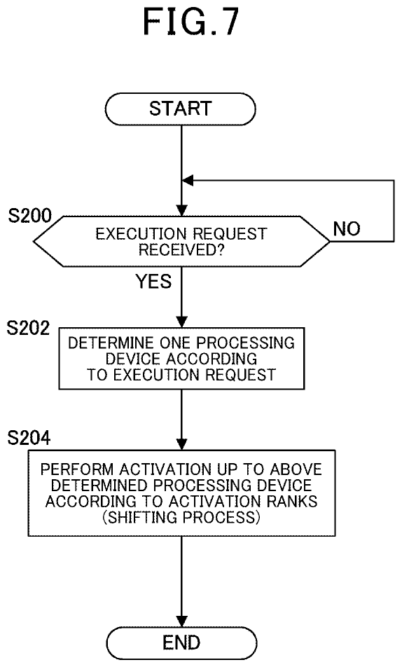

Next, the procedure of activating the processing devices 44 by the central ECU 2 will be described. FIG. 7 is a flowchart of the process to activate the processing devices 44, executed by the reception unit 61 and the activation unit 62 included in the processor 40 of the central ECU 2. The process shown in FIG. 7 is executed repeatedly.

When the process starts, first, the reception unit 61 determines whether it has received an execution request (S200). If the reception unit 61 has not received an execution request (S200, NO), the reception unit 61 keeps waiting for receiving an execution request while repeating step S200. In contrast, if the activation unit 62 has received an execution request (S200, YES), the activation unit 62 determines one processing device 44 determined by the received execution request (S202).

Next, the activation unit 62 executes a shifting process to perform activation up to the above determined one processing device 44 according to the activation ranks assigned to the processing devices 44 (S204) and then ends this process.

### OTHER EMBODIMENTS

Although the foregoing embodiment is based on the assumption that the multicore processor 42 in which the processing devices (441, 442, 443) that are sequentially activated are implemented and the processor 40 in which the function elements (60, 61, 62) including the activation unit 62 are implemented are different processors, these processing devices and the function elements may be implemented in one multicore processor. Although the foregoing embodiment is based on the assumption that the processing devices 44 are implemented by the processor cores 43 included in the multicore processor 42, the processing devices 44 may be implemented by different independent processors. In this case, the processing devices 44 may be virtual machines implemented by such independent processors on the host operating systems.

Although the foregoing embodiment is based on the assumption that the targets of the activation management performed by the reception unit 61 and the activation unit 62 of the central ECU 2 are the processing devices 44 included in the same central ECU 2, the configuration is not limited to this example, but the targets of the activation management may include processing devices included in other electronic devices different from the central ECU 2.

An alternative configuration may be such that personal authentication of the driver is performed to give permission to the driver to start the operation of the vehicle or permission to operate the driving device. In this case, for example, when the driver's seat door of the host vehicle is opened, the monitoring processing device 443 obtains an image of the driver from the DMC 18 and transmits it to the entry processing device 441. The entry processing device 441 performs personal authentication of the driver based on the image of the driver received from the monitoring processing device 443 and gives the second zone ECU 24 permission to operate the driving device.

Note that the present invention is not limited to the configurations of the above embodiments but may be implemented in various configurations within a range not departing from the spirit thereof.

For example, although the processing devices 44 are devices mounted on a vehicle and involved in operation control of the vehicle in the foregoing embodiment, the processing devices 44 may be any processing devices having any functions (for example, the foregoing MFP or the like).

[Configurations Supported by Above Embodiments]

The above embodiments support the following configurations.

(Configuration 1) An electronic device including: a reception unit that receives an execution request to execute a function in which at least one of a plurality of processing devices is involved; and an activation unit that, when the reception unit receives the execution request, shifts all or some of the processing devices to activated states, in which the activation unit, when the reception unit receives the execution request, executes a shifting process to shift the plurality of processing devices to the activated states according to activation ranks respectively assigned to the processing devices, in descending order of the activation ranks, but in the shifting process, does not shift, to the activated states, the processing devices having lower activation ranks than one of the processing devices determined according to the received execution request.

With the electronic device according to configuration 1, since the range of processing devices activated is limited according to the kind of execution request, it is possible to reduce the number of processing devices activated unnecessarily to reduce the electric power consumption.

(Configuration 2) The electronic device according to configuration 1, in which the plurality of processing devices include a physical machine and/or a virtual machine implemented in a processor.

With the electronic device according to configuration 2, not only for processing devices that are individual devices but also for processing devices that can be implemented in various forms in a processor, it is possible to reduce the number of processing devices activated unnecessarily to reduce the electric power consumption.

(Configuration 3) The electronic device according to configuration 1, in which the plurality of processing devices include a physical machine and/or a virtual machine implemented in a processor core included in a multicore processor.

With the electronic device according to configuration 3, for example, not only for processing devices implemented on a processor which is an individual semiconductor chip but also for processing devices implemented on a plurality of processor cores included in a multicore processor formed on a semiconductor chip, it is possible to reduce the number of processing devices activated unnecessarily to reduce the electric power consumption.

(Configuration 4) The electronic device according to any one of configurations 1 to 3, in which the processing devices are devices mounted on a vehicle and involved in controlling the operation of the vehicle and include an entry processing device involved in a function for user entry to the vehicle, a travel-function processing device involved in a function for a traveling device of the vehicle, a monitoring processing device involved in a function of monitoring states of the vehicle and/or a driver, and an information-communication processing device involved in a function for an in-vehicle human-machine interface and/or a function for connection of communication between the vehicle and an external device.

With the electronic device according to configuration 4, as for processing devices mounted on a vehicle, it is possible to reduce the number of processing devices activated unnecessarily to reduce the electric power consumption.

(Configuration 5) The electronic device according to configuration 4, in which the activation ranks are assigned in advance sequentially to the entry processing device, the travel-function processing device, the monitoring processing device, and the information-communication processing device from the highest rank.

With the electronic device according to configuration 5, since activation ranks can be respectively assigned to the processing devices so that necessary processing devices can be sequentially activated along a series of operations that the user of the vehicle performs, for example, when getting in the vehicle, it is possible to effectively reduce the number of processing devices activated unnecessarily to reduce the electric power consumption in the vehicle.

(Configuration 6) The electronic device according to configuration 5, in which the execution requests include a key unlocking request for unlocking a vehicle door with an electronic key, and in a case in which the execution request received by the reception unit is the key unlocking request, the one processing device determined according to the received execution request is the entry processing device, and the activation unit, in the shifting process, does not shift, to the activated states, the travel-function processing device, the monitoring processing device, and the information-communication processing device which have lower activation ranks than the entry processing device.

With the electronic device according to configuration 6, since necessary processing devices can be sequentially activated along a series of operations that the user of the vehicle performs, for example, when getting in the vehicle, it is possible to more effectively reduce the number of processing devices activated unnecessarily to reduce the electric power consumption in the vehicle.

(Configuration 7) The electronic device according to configuration 5, in which the execution requests include a door-handle unlocking request for unlocking a driver's seat door by a door-handle operation, and in a case in which the execution request received by the reception unit is the door-handle unlocking request, the one processing device determined according to the received execution request is the travel-function processing device, and the activation unit, in the shifting process, does not shift, to the activated states, the monitoring processing device and the information-communication processing device which have lower activation ranks than the travel-function processing device.

With the electronic device according to configuration 7, since necessary processing devices can be sequentially activated along a series of operations that the user of the vehicle performs, for example, when getting in the vehicle, it is possible to more effectively reduce the number of processing devices activated unnecessarily to reduce the electric power consumption in the vehicle.

(Configuration 8) The electronic device according to configuration 6 or 7, in which the execution requests include a driver's-seat-door related request for an opening operation of a driver's seat door, and in a case in which the execution request received by the reception unit is the driver's-seat-door related request, the one processing device determined according to the received execution request is the monitoring processing device, and the activation unit, in the shifting process, does not shift, to the activated state, the information-communication processing device which has a lower activation rank than the monitoring processing device.

With the electronic device according to configuration 8, since necessary processing devices can be sequentially activated along a series of operations that the user of the vehicle performs, for example, when getting in the vehicle, it is possible to more effectively reduce the number of processing devices activated unnecessarily to reduce the electric power consumption in the vehicle.

(Configuration 9) The electronic device according to configuration 6, in which the execution requests include a non-driver's-seat-door related request for an opening operation of doors other than a driver's seat door, and in a case in which the execution request received by the reception unit is the non-driver's-seat-door related request, the one processing device determined according to the received execution request is the travel-function processing device, and the activation unit, in the shifting process, does not shift, to the activated states, the monitoring processing device and the information-communication processing device which have lower activation ranks than the travel-function processing device.

With the electronic device according to configuration 9, since necessary processing devices can be sequentially activated along a series of operations that the user of the vehicle performs, for example, when getting in the vehicle, it is possible to more effectively reduce the number of processing devices activated unnecessarily to reduce the electric power consumption in the vehicle.

(Configuration 10) The electronic device according to configuration 5, in which the execution requests include a charge related request for charging the vehicle from an external charging device, and in a case in which the execution request received by the reception unit is the charge related request, the one processing device determined according to the received execution request is the travel-function processing device, and the activation unit, in the shifting process, does not shift, to the activated states, the monitoring processing device and the information-communication processing device which have lower activation ranks than the travel-function processing device.

With the electronic device according to configuration 10, since the range of processing devices activated is limited according to the kind of operation performed by the user of the vehicle, it is possible to more effectively reduce the number of processing devices activated unnecessarily to reduce the electric power consumption in the vehicle.

(Configuration 11) An activation management method executed by a computer of an electronic device that manages activation of a plurality of processing devices, the method including: receiving an execution request to execute a function in which at least one of a plurality of processing devices is involved; and shifting, when receiving the execution request, all or some of the processing devices to activated states, in which in the shifting, a shifting process is executed to shift the plurality of processing devices to the activated states according to activation ranks respectively assigned to the processing devices, in descending order of the activation ranks, but in the shifting process, the processing devices having lower activation ranks than one of the processing devices determined according to the received execution request are not shifted to the activated states.

With the activation management method according to configuration 11, since the range of processing devices activated is limited according to the kind of execution request, it is possible to reduce the number of processing devices activated unnecessarily to reduce the electric power consumption.

### REFERENCE SIGNS LIST

1 control system
2 central ECU
3a, 3b first communication line
4a, 4b, 4c second communication line
6 IVI
10 meter panel
12 TCU
18 DMC
23 first zone ECU
24 second zone ECU
29 third zone ECU
30, 30a, 30b, 30c, 30d, 30e, 30f, 30g, 30h ECU
36 entry ECU
40 processor
41 memory
42 multicore processor
43 processor core
431 first processor core
432 second processor core
433 third processor core
44 processing device
441 entry processing device
442 travel-function processing device
443 monitoring processing device
444 information-communication processing device
451 entry processing unit
452 travel-function processing unit
453 monitoring processing unit
454 information-communication processing unit
46 first communication device
47 second communication device
48 control program
49 first program
50 second program
51 third program
60 communication control unit
61 reception unit
62 activation unit

What is claimed is:

1. An electronic device comprising:
a reception unit that receives an execution request to execute a function in which at least one of a plurality of processing devices is involved; and
an activation unit that, when the reception unit receives the execution request, shifts all or some of the processing devices to activated states, wherein
the activation unit, when the reception unit receives the execution request,
executes a shifting process to shift the plurality of processing devices to the activated states according to activation ranks respectively assigned to the processing devices, in descending order of the activation ranks, but
in the shifting process, does not shift, to the activated states, the processing devices having lower activation ranks than one of the processing devices determined according to the received execution request.

2. The electronic device according to claim 1, wherein
the plurality of processing devices include a physical machine and/or a virtual machine implemented in a processor.

3. The electronic device according to claim 1, wherein
the plurality of processing devices include a physical machine and/or a virtual machine implemented in a processor core included in a multicore processor.

4. The electronic device according to claim 1, wherein
the processing devices are devices mounted on a vehicle and involved in controlling the operation of the vehicle and include
an entry processing device involved in a function for user entry to the vehicle,
a travel-function processing device involved in a function for a traveling device of the vehicle,
a monitoring processing device involved in a function of monitoring states of the vehicle and/or a driver, and
an information-communication processing device involved in a function for an in-vehicle human-machine interface and/or a function for connection of communication between the vehicle and an external device.

5. The electronic device according to claim 4, wherein
the activation ranks are assigned in advance sequentially to the entry processing device, the travel-function processing device, the monitoring processing device, and the information-communication processing device from the highest rank.

6. The electronic device according to claim 5, wherein
the execution requests include a key unlocking request for unlocking a vehicle door with an electronic key, and
in a case in which the execution request received by the reception unit is the key unlocking request,
the one processing device determined according to the received execution request is the entry processing device, and
the activation unit, in the shifting process, does not shift, to the activated states, the travel-function processing device, the monitoring processing device, and the information-communication processing device which have lower activation ranks than the entry processing device.

7. The electronic device according to claim 5, wherein
the execution requests include a door-handle unlocking request for unlocking a driver's seat door by a door-handle operation, and
in a case in which the execution request received by the reception unit is the door-handle unlocking request,
the one processing device determined according to the received execution request is the travel-function processing device, and
the activation unit, in the shifting process, does not shift, to the activated states, the monitoring processing device and the information-communication processing device which have lower activation ranks than the travel-function processing device.

8. The electronic device according to claim 6, wherein
the execution requests include a driver's-seat-door related request for an opening operation of a driver's seat door, and
in a case in which the execution request received by the reception unit is the driver's-seat-door related request,
the one processing device determined according to the received execution request is the monitoring processing device, and
the activation unit, in the shifting process, does not shift, to the activated state, the information-communication processing device which has a lower activation rank than the monitoring processing device.

9. The electronic device according to claim 6, wherein
the execution requests include a non-driver's-seat-door related request for an opening operation of doors other than a driver's seat door, and
in a case in which the execution request received by the reception unit is the non-driver's-seat-door related request,
the one processing device determined according to the received execution request is the travel-function processing device, and
the activation unit, in the shifting process, does not shift, to the activated states, the monitoring processing device and the information-communication processing device which have lower activation ranks than the travel-function processing device.

10. The electronic device according to claim 5, wherein
the execution requests include a charge related request for charging the vehicle from an external charging device, and
in a case in which the execution request received by the reception unit is the charge related request,
the one processing device determined according to the received execution request is the travel-function processing device, and
the activation unit, in the shifting process, does not shift, to the activated states, the monitoring processing device and the information-communication processing device which have lower activation ranks than the travel-function processing device.

11. An activation management method executed by a computer of an electronic device that manages activation of a plurality of processing devices, the method comprising:
receiving an execution request to execute a function in which at least one of a plurality of processing devices is involved; and
shifting, when receiving the execution request, all or some of the processing devices to activated states, wherein
in the shifting, a shifting process is executed to shift the plurality of processing devices to the activated states according to activation ranks respectively assigned to the processing devices, in descending order of the activation ranks, but
in the shifting process, the processing devices having lower activation ranks than one of the processing devices determined according to the received execution request are not shifted to the activated states.
